(19) United States
(12) Patent Application Publication
(10) Pub. No.: US 2025/0330090 A1
(43) Pub. Date: Oct. 23, 2025

(54) DYNAMIC SWITCHING FREQUENCY CONTROL OF POWER CONVERTER

(71) Applicant: Airborn, LLC, Georgetown, TX (US)

(72) Inventors: Andrew Tarnow, Windsor, SC (US); Donald J. Lucas, Windham, NH (US); Carl Cody, Erie, PA (US); Tristan Kuhns, Lake City, PA (US); Nathan Groover, Erie, PA (US); Brian Mroczkowski, Erie, PA (US); Gary VanMeter, Lake City, PA (US); William Cermak, Fairview, PA (US); Scott Poole, Girard, PA (US)

(21) Appl. No.: 19/184,160

(22) Filed: Apr. 21, 2025

Related U.S. Application Data
(60) Provisional application No. 63/636,923, filed on Apr. 22, 2024.

(51) Int. Cl. H02M 3/158; H02M 1/00

(52) U.S. Cl. CPC H02M 3/158; H02M 1/0058

(57) ABSTRACT

Disclosed are various embodiments for controlling the switching frequency of a switching device of a power converter. Measured or computed parameters are obtained. One or more of the parameters are real-time measurements from one or more sensors. A controller selects one of the parameters as a target parameter. The target parameter is represented as an objective function that defines criteria for optimizing the objective function as minimizing, maximizing, or obtaining a particular value for the target parameter. The controller implements a machine learning algorithm to determine a selected switching frequency of the switching device that optimizes the objective function, and controls the switching device to operate at the selected switching frequency.

### BACKGROUND

A power converter is an electrical device that converts an input electrical energy to an output electrical energy. Generally, the converter transforms or regulates input voltage from a source to an output voltage needed by a load. The power converter may be an alternating current (AC) to direct current (DC) converter (typically referred to as a transformer), a DC to AC converter (typically referred to as an inverter), or a DC to DC converter. A DC to DC converter may provide electrical isolation between the input and output, maintain a constant output voltage regardless of the load, or regulate the output voltage. A DC to DC converter that regulates the output voltage is a switched-mode power supply (SMPS) that uses a switching element, along with components like inductors and capacitors, to transfer energy.

Among the different types of SMPS converters is a boost converter that increases the input voltage and a buck converter that decreases the input voltage to generate the output voltage needed by a system or device being powered (e.g., the load). In SMPS converters, output current flow is affected by the operation of the switching elements, as well as by the input power signal, other components used, and the circuit topology. An SMPS converter may employ a soft switching technique or a hard switching technique.

A hard switching technique implements switching control on a switching element of the SMPS converter (i.e., turns the switching element on and off) without consideration of the voltage and/or current condition across the switching element. A soft switching technique employs an additional circuit to turn a switching element on and off at zero current or zero voltage or to control switching timing of the voltage and current to minimize intersection of the current and voltage waveforms.

### BRIEF SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures.

Various embodiments are disclosed for a dynamic switching frequency controller of a power converter. An example converter includes a switching device and a controller. The controller obtains parameters of the converter. The parameters are measured or computed, and one or more of the parameters are real-time measurements from one or more sensors. The controller selects a target parameter. The target parameter is one of the parameters, and the target parameter is represented as an objective function that defines criteria for optimizing the objective function as minimizing, maximizing, or obtaining a particular value for the target parameter. The controller implements a machine learning algorithm to determine a selected switching frequency of the switching device that optimizes the objective function and controls the switching device to operate at the selected switching frequency.

In some aspects, the power controller also includes an additional switching device, and an inductive element. A first terminal of the inductive element is connected between the switching device and the additional switching device, a second terminal of the inductive element is an output terminal of the power converter, and the additional switching device is a one-way switch. In some aspects, the switching device is a metal-oxide-semiconductor field-effect transistor (MOSFET), and the controller applies, to the switching device, a pulse width modulation signal with a frequency set to the switching frequency. In some aspects, the parameters include temperature and efficiency of the converter. The efficiency is computed using input current, input voltage, output current, and output voltage values. The output current and the output voltage values are among the one or more of the parameters that are real-time measurements.

In other aspects, the controller selects the target parameter and the objective function representing the target parameter based on comparing each of one or more of the parameters with a respective predefined minimum or maximum threshold value for the parameter. In some aspects, the controller implements a probe and observe algorithm as the machine learning algorithm to optimize the objective function representing the target parameter by incrementally changing the switching frequency and observing a resulting value of the target parameter. In other aspects, the controller implements the machine learning algorithm through a trained machine learning model that predicts a value of the selected switching frequency.

In some aspects, the controller selects two or more target parameters, the two or more target parameters being represented by respective two or more objective functions. The controller generates a combined objective function as a weighted sum of the two or more objective functions. In some aspects, the controller implements the machine learning algorithm to determine the selected switching frequency that optimizes the combined objective function. In other aspects, the controller implements the machine learning algorithm to determine the switching frequency that optimizes one of the two or more objective functions by using another of the two or more objective functions as a constraint. In other aspects, the controller sorts the two or more target parameters by a priority order and to implement two or more machine learning algorithms to optimize the two or more objective functions according to the priority order. In some aspects, the controller selects the target parameter, determines the selected switching frequency, and controls the switching device to operate at the selected switching frequency iteratively.

An exemplary converter includes a first switching device, a second switching device, and an inductive element. A first terminal of the inductive element is connected between the first switching device and the second switching device and a second terminal of the inductive element is an output terminal of the power converter. The converter includes a controller to control a switching frequency of the first switching device based on one of a plurality of switching frequency schedules. In some aspects, each of the plurality of switching frequency schedules indicates a value of a parameter of interest associated with each of a plurality of pairings of switching frequency values with values of a parameter of the converter. In some aspects, based on the one of the plurality of switching frequency schedules, the controller controls the switching frequency of the first switching device according to a measured value of the parameter and one of the switching frequency values paired with the measured value of the parameter associated with a desired value of the parameter of interest.

In some aspects, the controller selects the one of the plurality of switching frequency schedules based on one or more measured values indicating real-time conditions of the converter. In some aspects, the parameter of interest is efficiency computed using input current, input voltage, output current, and output voltage, and the desired value of the parameter of interest is a maximum efficiency associated with the measured value of the parameter and the switching frequency values.

An exemplary method for controlling a power converter includes obtaining parameters of the power converter. The parameters are measured or computed, and one or more of the parameters are real-time measurements from one or more sensors. The method also includes selecting a target parameter. The target parameter is one of the parameters, and the target parameter is represented as an objective function that defines criteria for optimizing the objective function as minimizing, maximizing, or obtaining a particular value for the target parameter. A machine learning algorithm is implemented to determine a selected switching frequency of the switching device that optimizes the objective function, and the switching device is controlled to operate at the selected switching frequency.

In some aspects, the method also includes implementing a probe and observe algorithm as the machine learning algorithm to optimize the objective function representing the target parameter by incrementally changing the switching frequency and observing a resulting value of the target parameter. In some aspects, implementing the machine learning algorithm includes implementing a trained machine learning model that predicts a value of the selected switching frequency.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a circuit diagram of a switched-mode power supply (SMPS) buck converter according to various embodiments of the present disclosure.

FIG. 2 is a block diagram of aspects of the controller according to various embodiments of the present disclosure.

FIG. 3A is an exemplary switching frequency schedule used to select a switching frequency according to various embodiments of the present disclosure.

FIG. 3B is an exemplary switching frequency schedule similar to the switching frequency schedule in FIG. 3A.

FIG. 4 is a process flow of a method of controlling the switching frequency of a converter according to various embodiments of the present disclosure.

FIG. 5 is a process flow of a method of controlling the switching frequency of a converter by implementing machine learning according to various embodiments of the present disclosure.

### DETAILED DESCRIPTION

As noted above, a switched-mode power supply (SMPS) converter is a DC to DC converter that can control the voltage generated at the output to appropriately power a load. The SMPS converter may implement soft switching via a resonant circuit or hard switching, which entails directly controlling the switching element. In the case of soft switching, switching frequency directly influences power transfer and output voltage. Thus, the switching frequency may be used as a throttle on power flow through the converter. In the case of hard switching, the output power of the converter is not directly tied to switching frequency. Rather, switching frequency can have a non-linear relationship with power flow through the non-resonant SMPS converter.

Recognizing that switching frequency may be used to optimize one or a combination of parameters of an SMPS converter implementing hard switching, without directly affecting output power, aspects of switching frequency control in a power converter are described. One or more parameters of the power converter (e.g., temperature, efficiency, and so forth) may be monitored during operation of the power converter. The real-time value of one or more of the monitored parameters may lead to the selection of switching frequency based on one or more predefined switching frequency schedules. A machine learning model may be implemented to determine switching frequency according to one or more objective functions. Selection of a switching frequency schedule or an objective function may be based on the monitored real-time conditions. In the following discussion, a general description of various embodiments of switching frequency control is provided.

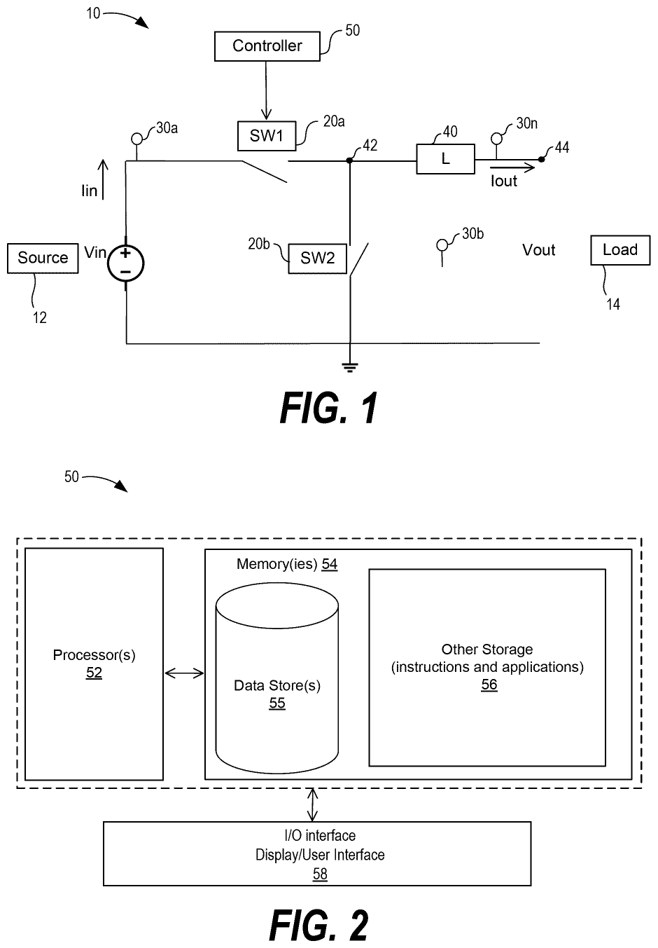

Turning to the drawings, FIG. 1 is a simplified circuit diagram of an SMPS buck converter 10 according to various embodiments of the present disclosure. The input voltage (Vin) and input current (lin) at the source 12 of the converter 10 are indicated along with the output voltage (Vout) and output current (Iout) supplied to the load 14. The converter 10 includes a first switching device (SW1) 20a and a second switching device (SW2) 20b. In exemplary embodiments, the first switching device 20a may be a transistor (e.g., metal-oxide-semiconductor field-effect transistor (MOSFET)) and the second switching device 20b may be a rectifying diode or another MOSFET.

An inductive element (L) 40 is connected, with one of its terminals 42 connected between the first switching device 20a and the second switching device 20b and another terminal being an output terminal 44 of the converter 10. The converter 10 may include any number of sensors 30a through 30n (generally referred to as sensor 30) to measure voltage, current, temperature, and other parameters. Exemplary sensors 30 indicated in FIG. 1 include an input current sensor 30a, temperature sensor 30b, and output current sensor 30n, although it is understood that further sensor types may be employed.

The sensors 30 may be known sensors for measuring some parameters such as, for example, input voltage Vin, output voltage Vout, ambient temperature, device temperature, input current In, output current Iout, ripple current at a power supply interface, ripple voltage at the power supply interface, ripple current at a load interface, ripple voltage at the load interface, and so forth. Other parameters of interest may be determined from the measurements. For example, efficiency may be determined based on input current lin, input voltage Vin, output current Iout, and output voltage Vout as:

$$Efficiency = ( Iout * Vout ) / ( Iin * Vin ) \qquad EQ . 1$$

Other exemplary parameters that may be measured or calculated include device losses, operating duty cycle, ratio of input to output voltage, and power level. The examples discussed herein are not intended to limit the numbers and positions of sensors 30 that may be used or the parameters that may be measured or determined according to known sensors and computations.

A controller 50 may control one or both of the switching devices 20a, 20b. For explanatory purposes, the first switching device 20a in the exemplary illustration in FIG. 1 can include a MOSFET that is turned on (i.e., creating a closed circuit path) or off (i.e., creating an open circuit path) and the second switching device 20b can include a diode that allows only one-way current flow through the diode to the terminal 42 of the inductor 40, but not through the diode from the terminal 42 of the inductor 40. General operation of the illustrated exemplary converter 10, which is a hard switching buck converter, is known and only generally shown and described here. For example, capacitors that are typically arranged in parallel with the source and/or load are omitted, as are resistors.

When the first switching device 20a is controlled to be on, input current lin flows to the terminal 42 of the inductor 40 and is prevented from flowing through the second switching device 20b, the diode. This represents a charging phase of the inductor 40, in which the inductor 40 stores energy in its magnetic field while supplying output current to the load 14. When the first switching device 20a is controlled to be off, the open circuit path through the first switching device 20a disconnects the source 12 from the load 14. Stored energy in the inductor 40 creates current flow through the load 14, facilitated by the loop formed via current flow through the second switching device 20b to the terminal 42 of the inductor 40. This represents the discharging phase of the inductor 40.

The rate at which the controller 50 turns the first switching device 20a on and off (i.e., the switching frequency), which controls the operating duty cycle of the converter 10, can affect a number of parameters. Thus, by changing the switching frequency, the controller 50 may control different aspects of operation of the converter 10. The basis for control of the first switching device 20a by the controller 50 may be dynamic (e.g., based on one or more real-time parameter values) and that basis itself may also be dynamically changed during operation of the converter 10.

In the context of dynamic control by the controller 50, real-time parameter values refer to values measured or computed based on measured values during operation of the converter 10. While “real-time” values are understood to be subject to measurement or computational delay, they do not refer to values obtained during a previous operation for post-operational use (e.g., as training data or to otherwise affect behavior of a controller during a different operational period).

For example, according to some aspects, switching frequency may be controlled based on measured load current Iout. The mapping between this real-time load current Iout and the switching frequency to be selected may be based on a predetermined schedule. As another example, according to some aspects, a machine learning algorithm may determine the switching frequency based on real-time conditions. In both cases, as further detailed below, the basis for the selection or determination of the switching frequency may be dynamically changed. For example, if observed ambient temperature or device temperature exceeds a predefined range during operation of the converter 10, the switching frequency may be selected or determined differently until temperature returns to within the predefined range.

When both the first switching device 20a and the second switching device 20b are MOSFETs or other controllable switching devices operated by the controller 50, the converter 10 may be operated as a boost converter instead of or as well as being operated as a buck converter. According to some embodiments, the controller 50, when controlling both the first switching device 20a and the second switching device 20b, may dynamically transform the converter 10 between operation as a buck converter and a boost converter. Further, the approaches to switching frequency control by the controller 50 discussed for a buck converter for explanatory purposes may extend to control of the first switching device 20a and the second switching device 20b for purposes of switching frequency control by the controller 50 for a boost converter.

FIG. 2 is a block diagram of aspects of the controller 50 according to various embodiments of the present disclosure. The controller 50 may include one or more processors 52 and memory 54. The memory 54 may include one or more data stores 55 where predetermined schedules, measured parameter values, and additional data may be retained. The memory 54 may also include other non-volatile storage 56 to store instructions and applications, such as one or more machine learning algorithms. An input/output (I/O) interface 58 may facilitate interaction with a display device or user interface. The input/output interface 58 may be used to update or add schedules or machine learning models, for example.

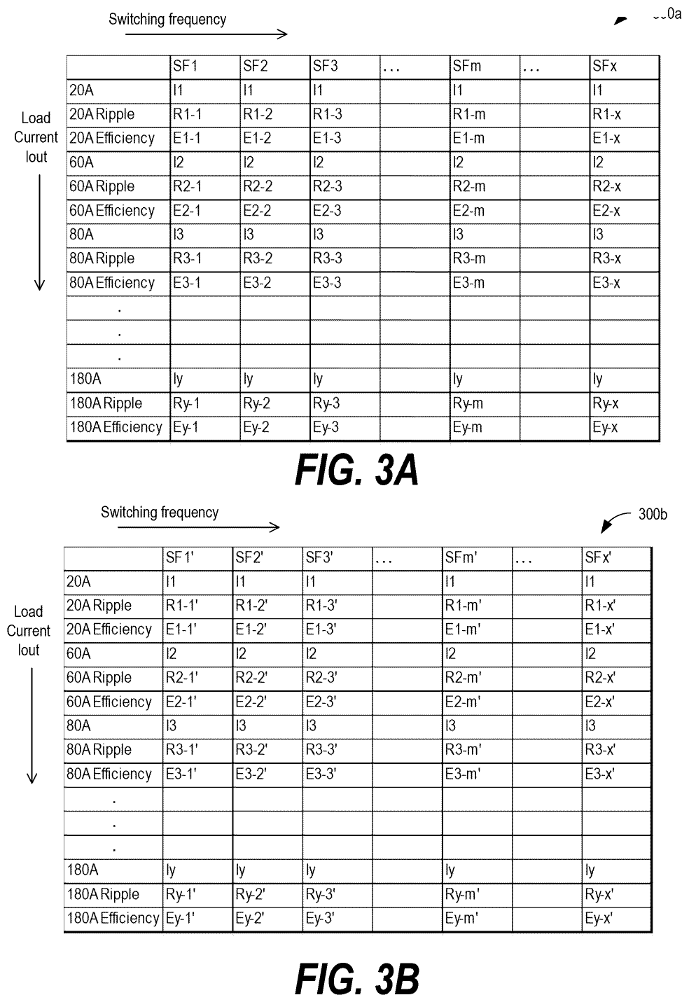

As noted above, the basis for dynamic control of the switching frequency by the controller 50 may be one or more real-time parameter values. Additionally, the basis for control may itself be dynamically changed. An example of switching frequency control is detailed with reference to FIGS. 3A and 3B.

FIG. 3A is an exemplary switching frequency schedule 300a and FIG. 3B is another switching frequency schedule 300b (generally referred to as switching frequency schedule 300) according to various embodiments of the present disclosure. The table representing the switching frequency schedule 300a may be predetermined for a particular ratio of Vin to Vout. The switching frequency schedule 300a shows load current values indicated from I1=20 amperes (A) to Iy=180 A. Switching frequency values are indicated as SF1 through SFx. Actual values are not indicated for explanatory purposes. For example, SF1 may be 60 kilohertz (kHz) and SFx may be 300 kHz. For each load current and switching frequency combination, the current ripple value R (e.g., in milliamperes (mA)) and efficiency E (e.g., as a percentage (%)) are indicated. Like the switching frequency, actual values are not indicated for explanatory purposes.

According to exemplary embodiments, for a given load current, switching frequency may be selected from the switching frequency schedule 300a as the one that provides maximum efficiency. For example, when the load current is I3 (80 A), E3-m may be the highest % efficiency value among E3-1 through E3-x. In this case, the controller 50 may control the switching frequency of the first switching device 20a to be SFm when the load current Iout is measured to be I3. As another example, when the load current is Iy (180 A), Ey-3 may be the highest % efficiency value among Ey-1 through Ey-x. In this case, the controller 50 may control the switching frequency of the first switching device 20a to be SFy when the load current Iout is measured to be Iy. The controller 50 selecting the switching frequency for the first switching device 20a by mapping measured load current Iout to the switching frequency associated with the highest efficiency value at the load current Iout is an example of dynamic selection of switching frequency based on a schedule.

FIG. 3B is an exemplary switching frequency schedule 300b that is similar to switching frequency schedule 300a shown in FIG. 3A, but represents values predetermined and recorded for a different ratio of Vin to Vout. For example, according to switching frequency schedule 300b, when the load current is I3 (80 A), E3-2′ may be the highest % efficiency value among E3-1′ through E3-x′. In this case, the controller 50 may control the switching frequency of the first switching device 20a to be SF2′ when the load current Iout is measured to be I3.

According to exemplary embodiments, the controller 50 may first determine which schedule to use (e.g., switching frequency schedule 300a or switching frequency schedule 300b). This determination may be based on obtaining a ratio of measured Vin to measured Vout and deciding whether the real-time ratio obtained with measured values is closest to the Vin to Vout ratio associated with switching frequency schedule 300a or with switching frequency schedule 300b. That is, each of the switching frequency schedules 300a and 300b represents a switching frequency schedule

Switching frequency schedules 300a and 300b each represent a switching frequency schedule 300 that facilitates mapping the switching frequency to a measured or computed parameter (load current in the example) based on a goal (maximizing efficiency in the example). Together, switching frequency schedules 300a and 300b represent a set of switching frequency schedules 300 with the same mapping for different values of another measured or computed parameter (Vin/Vout in the example).

The exemplary switching frequency schedules 300a and 300b are not intended to limit the parameter(s) to which the switching frequency may be mapped nor the goal of the mapping. In addition, multiple switching frequency schedules 300 that form a set may be generated based on a different measured or computed parameter. For example, switching frequency schedules 300 may map switching frequency to output voltage Vout and selection of a given switching frequency for a given output voltage Vout may be based on minimizing noise on the load. Two or more of the switching frequency schedules 300 mapping switching frequency to output voltage Vout may be generated for two or more ambient temperature ranges.

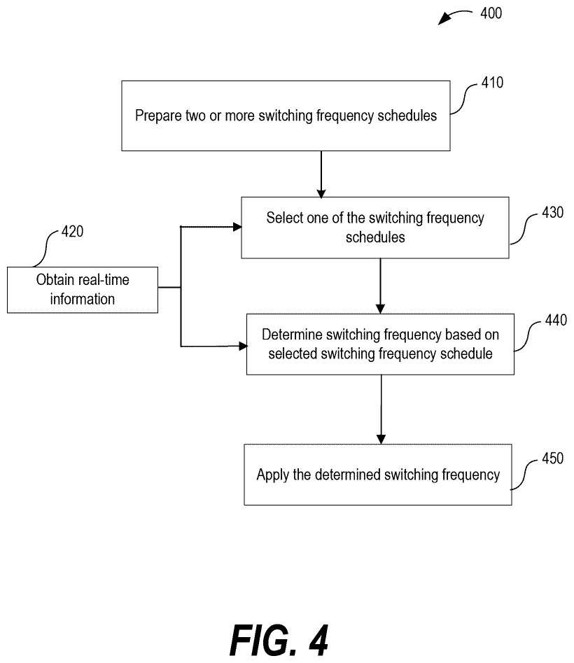

FIG. 4 is a process flow of a method 400 of controlling the switching frequency of a converter 10 according to various embodiments of the present disclosure. The processes discussed with reference to FIG. 4 may be implemented by the controller 50 and, more specifically, by one or more processors 52, based on instructions and data stored in memory 54.

At 410, preparing two or more switching frequency schedules 300 refers to generating switching frequency schedules 300a and 300b of FIGS. 3A and 3B, for example. While the switching frequency schedules 300a and 300b are discussed for explanatory purposes, as previously noted, the examples are not intended to be limiting. Any number of switching frequency schedules 300 and switching frequency schedule sets may be generated and may map switching frequency to one or more parameters that are measured or determined in real-time. The generation of a switching frequency schedule 300 may be based on experimentation, simulation, or computation (e.g., using a polynomial representation).

At 420, obtaining real-time information may refer to obtaining one or more measurements from one or more sensors 30 discussed with reference to FIG. 1. The controller 50 may additionally obtain information using the input/output interface 58. This information may be an instruction from an operator, for example, provided using an appropriate input device.

At 430, selecting one of the switching frequency schedules 300 may involve more than one selection. For example, two sets of switching frequency schedules 300 may be prepared at 410. One set may be switching frequency schedules 300a and 300b, and another set of switching frequency schedules 300 may map the switching frequency to another measured parameter (e.g., output voltage Vout) based on another goal (e.g., minimizing load voltage ripple). The switching frequency schedules 300 of the second set may be generated for different converter temperature ranges.

In this case, selecting one of the switching frequency schedules 300, at 430, involves first selecting one of the sets of switching frequency schedules 300 from among the two (or more) sets. This selection may be based on an operator instruction obtained at 420, for example. The selection may, instead, be based on a measured parameter. Once one of the sets of switching frequency schedules 300 is selected, one switching frequency schedule 300 within the selected set may be selected based on the parameter that differs among the switching frequency schedules 300 of the set (e.g., ratio of Vin to Vout if the selected set includes switching frequency schedules 300a and 300b).

At 440, determining the switching frequency based on the selected switching frequency schedule 300 refers to implementing the mapping specific to the selected switching frequency schedule 300. For example, if the switching frequency schedules 300a is selected, the switching frequency is selected based on the real-time value of load current Iout obtained at 420. Specifically, the switching frequency is determined as the value associated with the highest value of efficiency for the real-time value of load current Iout obtained at 420. If, as another example, a different switching frequency schedule 300 is selected at 430, the mapping particular to that switching frequency schedule 300 (e.g., switching frequency to output voltage Vout) and the goal driving the selection of switching frequency (e.g., minimizing load voltage ripple) may be used.

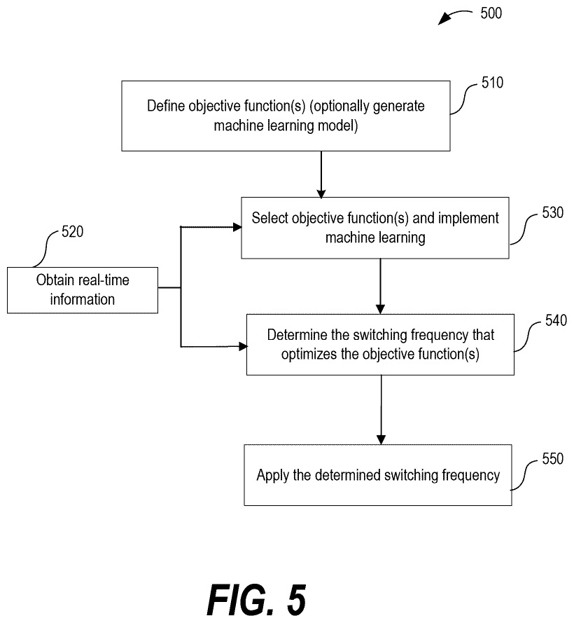

At 450, applying the determined switching frequency refers to the controller 50 applying a PWM signal with the switching frequency determined at 440. According to the exemplary configuration of FIG. 1, the controller 50 controls the first switching device 20a based on the switching frequency determined at 440. The controller 50 may generate a pulse width modulation (PWM) signal to operate the first switching device 20a at the determined switching frequency. As discussed with reference to FIG. 5, the mapping captured by a switching frequency schedule 300 may be generalized for implementation of a machine learning algorithm by the controller 50.

As noted with reference to FIG. 3A, for example, switching frequency is determined for a given load current Iout based on a goal of maximizing efficiency. Rather than generating a table, the mapping may be represented as an objective function. In machine learning, an objective function represents a variable as a function of constraints, whose values cannot be controlled, and one or more decision variables, whose values can be controlled. The objective function encapsulates criteria for optimizing the variable (i.e., minimizing, maximizing, or setting to a particular value).

In the exemplary case of FIG. 3A, for constraints including Vin/Vout and load current Iout, efficiency may be represented by an objective function with switching frequency as the decision variable and a criteria of maximizing the value of efficiency. For explanatory purposes, efficiency may be referred to as the target parameter. As discussed below, the optimization may be performed by implementing a machine learning algorithm or a trained machine learning model. In addition, multi-objective optimization may be used to optimize multiple target parameters simultaneously or in turn.

FIG. 5 is a process flow of a method 500 of controlling the switching frequency of a converter by implementing machine learning according to various embodiments of the present disclosure. The processes shown in FIG. 5 may be implemented by the controller 50 of the converter 10. A known machine learning algorithm (e.g., linear regression algorithm, logistic regression, decision tree, random forest algorithm, etc.) or one designed for a particular objective function may be used to optimize an objective function. In some cases, a machine learning model may be generated following a supervised or unsupervised training process on the machine learning algorithm. In some cases, another type of training, called reinforcement learning, may be implemented in a dynamic environment (i.e., during operation of the converter 10).

For example, rather than pre-generating the switching frequency schedules 300a and 300b using experimentation, simulation, or computation, a perturb and observe algorithm, an exemplary reinforcement machine learning algorithm, may be implemented by the controller 50. In the exemplary case, the controller 50 may perturb the decision variable (e.g., increase the switching frequency from the current value) to observe the effect on the objective function (e.g., increase or decrease in efficiency).

If efficiency increases based on the perturbation, the controller 50 may further increase the switching frequency, incrementally, until further increases in switching frequency no longer increase efficiency (that is, until maximum efficiency has been reached). In this way, the switching frequency associated with the maximum efficiency can be identified dynamically. For example, the controller 50 may increase the switching frequency by 10 kHz increments while obtaining real-time values of input current lin, output current Iout, input voltage Vin, and output voltage Vout from sensors 30 and performing the computation of EQ. 1 to determine resulting efficiency.

If, instead, the computed efficiency value decreased based on the initial increase in switching frequency, the controller 50 may decrease the switching frequency from the initial switching frequency value and follow a similar, incremental procedure to identify the switching frequency to be applied to the first switching device 20a to maximize efficiency.

In some cases, based on the objective function of interest, a training process may be implemented, prior to operational implementation in the converter 10, to generate a machine learning model. In these cases, the controller 50 may implement the machine learning model to predict the switching frequency to apply to the first switching device 20a in order to achieve the objective function (e.g., maximize efficiency, minimize load current ripple). The training process may be supervised, semi-supervised, or unsupervised.

In addition, while one parameter (e.g., efficiency, load current ripple) is discussed as an objective function in various examples, multiple parameters may be optimized simultaneously or in turn, (i.e., multiple-objective optimization may be implemented) based on the particular objective function(s) defined and used according to exemplary embodiments. In some cases, a single objective function may be generated as a weighted sum of two or more objective functions. Thus, optimization of the two or more parameters according to the two or more objective functions may be prioritized through the weighting. In some cases, one or more objective functions may be used to constrain the optimization process of one or more other objective functions. For example, the above-discussed example of maximizing efficiency may be constrained by a maximum allowable device temperature. In some cases, a lexicographic approach may be defined to prioritize objective functions for optimization in sequence. Any known approach is contemplated by various embodiments of the present disclosure.

While only a few algorithms are discussed for explanatory purposes, the particular objective function(s), selected machine learning algorithm(s), and, where applicable, the training approach(es) are not intended to be limited by the examples. Additional non-limiting examples and approaches are discussed below.

Returning to the process flow of the method 500 shown in FIG. 5, at 510, defining one or more objective functions refers to defining one parameter (e.g., efficiency, voltage ripple, temperature) to be optimized (e.g., minimized or maximized), alone or in combination with other parameters in a multiple-objective optimization. As indicated, based on the objective function and a suitable machine learning algorithm to optimize the objective function, training may be performed to generate a machine learning model. At 520, obtaining real-time information may refer to obtaining one or more measurements from one or more sensors 30 and/or obtaining information using the input/output interface 58, as discussed with reference to FIG. 4 for 420.

At 530, selecting one or more objective functions and implementing machine learning may be based on real-time conditions. The selection itself may involve implementing a machine learning algorithm or may be based on a mapping or program including conditional statements or other selection approach. For example, the controller 50 may obtain measurements of input current lin, output current Iout, input voltage Vin, output voltage Vout, output voltage ripple, ambient temperature, and device temperature from sensors 30 of the converter 10 at 520. The controller 50 may compute a real-time efficiency value based on EQ. 1. The controller 50 may then use the real-time values of efficiency, output voltage ripple, ambient temperature, and device temperature to select one or more objective functions in one of several ways.

In some cases, the controller 50 may implement a series of conditional statements to determine whether output voltage ripple, ambient temperature, or device temperature are above a predefined threshold value. The controller 50 may select one or more objective functions based on which of the checked parameters, among output voltage ripple, ambient temperature, and device temperature, exceed their respective predefined threshold. The controller 50 may additionally select the objective function pertaining to maximizing efficiency in any case. Thus, if one or more of the checked parameters are above their predefined threshold, the controller 50 may select a multi-objective optimization to optimize efficiency and those one or more checked parameters.

For example, if device temperature is found to be above a predefined threshold, an objective function pertaining to maximizing efficiency may be selected for optimization using an objective function pertaining to minimizing device temperature as a constraint. As another example, efficiency and/or output voltage ripple may be combined with device temperature to generate an objective function as a weighted sum of their individual objective functions. Any number of parameters may be selected as target parameters. That is, one or more objective functions may be selected and any available machine learning algorithm or model may be implemented at 530. When two or more objective functions are selected, any known multi-objective optimization technique may be implemented.

At 540, determining the switching frequency that optimizes the objective functions(s) refers to determining the switching frequency that optimizes one or more individual objective functions or a weighted sum. The determination may be based on implementing a probe and observe machine learning algorithm, a machine learning model, or some combination (in the case of a multiple-objective optimization). At 550, applying the determined switching frequency refers to the controller 50 applying a PWM signal with the switching frequency determined at 540. According to the exemplary configuration of FIG. 1, the controller 50 controls the first switching device 20a based on the switching frequency determined at 540.

During operation of the converter 10, the processes at 420-450 of the method 400 set out in FIG. 4 or processes 520-550 of the method 500 set out in FIG. 5 may be performed iteratively. The iterations may be periodic or may be triggered based on an event. An event-based trigger may involve obtaining measurements from sensors 30 and obtaining other parameters from computations based on measured values. For example, the controller 50 may determine that a measurement of device temperature exceeds a predefined threshold value and initiate another iteration of one of the methods 400, 500. As another example, a measurement of output voltage Vout may indicate that it is below a predefined minimum threshold or above a predefined maximum threshold. This may also trigger another iteration. The predefined threshold values may be stored in a data store 55 or may be provided or updated via the input/output interface 58. A next iteration of a method 400, 500 may also be triggered via the input/output interface 58.

As previously noted, various embodiments of the present disclosure are not limited by specific exemplary uses discussed herein. For example, efficiency, voltage ripple, and temperature are discussed as objective functions to be optimized and/or used as constraints. For example, operating frequency may be adjusted to optimize efficiency (e.g., minimized) while output voltage ripple staying within defined limits or below a predefined maximum value may be used as a constraint. Any number of other characteristics, or combination of characteristics of the converter 10, may be additionally or alternately used as objective functions for control of the switching frequency by the controller 50 according to various embodiments.

The machine learning algorithm, implementation, and/or training approach may also differ from specific examples without departing from the spirit of this disclosure or the scope of the claims. As previously noted, training may be used with a machine learning algorithm to generate parameter values and a predictive machine learning model. The training may be implemented by any known approach, and feedforward and feedback modeling and training approaches are briefly discussed. For example, a system model solved in real time may be a network of modeled components with parameters that are changed dynamically using measured parameter values from sensors 30. A feedforward or feedback approach may be used to change the properties of electrical elements in the computational system model in real time.

A feedback approach to adjusting parameter values may estimate electrical element values from measurements of voltages and currents or other parameters and adjust an estimated value for the electrical element over time based on a combination of the measurements and a historical state of the prior estimate using a mathematical function. This feedback estimation approach could provide a direct indication of inductance, for example, independent of the factors leading to its value. The feedback approach may benefit from a history of estimated values stored as a state and may allow for one or more models based on measurements to adjust the estimated parameter value over time as measured conditions change, to track changes in the value over time.

A feedforward approach may be used to adjust system model parameters that have a predicted behavior. For example, an inductance value may be dynamically adjusted as a function of average current. This approach may be used if there is no means to directly estimate the inductance, for example, through real time measurements of performance. Instead, the approach relies on a model determined in advance to predict the value of the electrical element (e.g., inductance as a function of average current). Unlike the feedback approach, this approach does not require or benefit from a history of operating state.

The machine learning model would then determine, through computation values of the objective function and constraints, the present state of the estimated parameters. For example, the system model may be used to determine losses as a function of operating point as well as output voltage ripple, and use these calculated values for calculating an objective function such as efficiency while also calculating the value of a constraining limit, such as output voltage ripple in real time. Thus, the component parameters such as resistance, inductance, charge may be estimated based on measured values such as current, temperature, voltage in real time, and the model in a given state may be used to do a constrained optimization in real time (e.g., to maximize operating frequency constrained by output voltage ripple).

An exemplary training approach uses a model of the system (actual system, electronic analog of the system, computationally modeled analog of the system, or mathematical model of the system) and creates a function that converts values that would be measured directly during operation to a switching frequency needed to meet the objective goals, such as maximizing operating efficiency while staying within performance constraints, for example. Because the machine learning model is predictive, it may be limited to feedforward based approaches that predict values based on present measurements, unless the learning model adds in additional states that are calculated at run time.

A feedforward only training may result in the generation of a function through curve fit that accepts measured values as arguments and returns a desired switching frequency, for example. A feedforward only training may also result in coefficient determination in a mathematical network that combines measured inputs into a desired output through linear or non-linear means, which may be implemented as a neural network. A feedforward only training may result in a lookup table where each measured parameter is an axis of the table and the desired switching frequencies for given combinations of measured parameters are determined and stored for each combination of measured parameter values. A lookup table may be implemented with or without interpolation between the stored values of switching frequencies. The preceding exemplary feedforward approaches do not require prior calculated states to be stored from one iteration to the next for operation. The controlled output (of switching frequency) is determined by the input at a given time step.

As noted, a training approach with feedback may be implemented as a computational neural network. One or more of the outputs of the computed neural network may be an estimated state based on measured inputs, and the estimated state may be fed back into the neural network as an input to the next iteration of calculation. This neural network-based approach, with states estimated by the neural network, may provide results similar to those discussed for the feedback approach described above. A similar result may be developed with any mathematical model or set of functions or tables that has feedback from a result of the model, functions, or tables back into an input to the same model, functions, or tables for a future iteration. These implementations may be machine learning approaches with offline training.

Although the machine learning algorithms and models, and other various systems described herein, may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 4 and 5 show the functionality and operation of an implementation of portions of the functionality of the controller 50. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 52 in a computer system or other system. The machine code may be converted from the source code, etc. If embodied in hardware, each block may represent a circuit or a number of interconnected circuits to implement the specified logical function(s).

Although the flowcharts of FIGS. 4 and 5 show a specific order of execution, it is understood that the order of execution may differ from that which is depicted. For example, the order of execution of two or more blocks may be scrambled relative to the order shown. Also, two or more blocks shown in succession in FIGS. 4 and 5 may be executed concurrently or with partial concurrence. Further, in some embodiments, one or more of the blocks shown in FIGS. 4 and 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, that comprises software or code can be embodied in any non-transitory computer-readable medium for use by or in connection with an instruction execution system such as, for example, a processor 52 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the controller 50 alone or in multiple computing devices in communication with the controller 50 via the input/output interface 58. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A power converter comprising:
a switching device; and
a controller configured to:
obtain parameters of the power converter, wherein
the parameters are measured or computed, and
one or more of the parameters are real-time measurements from one or more sensors;
select a target parameter, wherein
the target parameter is one of the parameters,
the target parameter is represented as an objective function that defines criteria for optimizing the objective function as minimizing, maximizing, or obtaining a particular value for the target parameter,
implement a machine learning algorithm to determine a selected switching frequency of the switching device that optimizes the objective function, and
control the switching device to operate at the selected switching frequency.

2. The power converter according to claim 1, further comprising:
an additional switching device; and
an inductive element, wherein
a first terminal of the inductive element is connected between the switching device and the additional switching device,
a second terminal of the inductive element is an output terminal of the power converter, and
the additional switching device is a one-way switch or a transistor.

3. The power converter according to claim 1, wherein the switching device is a metal-oxide-semiconductor field-effect transistor (MOSFET), wherein the controller is configured to apply, to the switching device, a pulse width modulation signal with a frequency set to the switching frequency.

4. The power converter according to claim 1, wherein the parameters include temperature and efficiency of the converter, wherein the efficiency is computed using input current, input voltage, output current, and output voltage values.

5. The power converter according to claim 4, wherein the output current and the output voltage values are among the one or more of the parameters that are real-time measurements.

6. The power converter according to claim 1, wherein the controller is configured to select the target parameter and the objective function representing the target parameter based on comparing each of one or more of the parameters with a respective predefined minimum or maximum threshold value for the parameter.

7. The power converter according to claim 1, wherein the controller is configured to implement a probe and observe algorithm as the machine learning algorithm to optimize the objective function representing the target parameter by incrementally changing the switching frequency and observing a resulting value of the target parameter.

8. The power converter according to claim 1, wherein the controller is configured to implement the machine learning algorithm through a trained machine learning model that predicts a value of the selected switching frequency.

9. The power converter according to claim 1, wherein the controller is configured to select two or more target parameters, the two or more target parameters being represented by respective two or more objective functions.

10. The power converter according to claim 9, wherein the controller is configured to generate a combined objective function as a weighted sum of the two or more objective functions.

11. The power converter according to claim 10, wherein the controller is configured to implement the machine learning algorithm to determine the selected switching frequency that optimizes the combined objective function.

12. The power converter according to claim 9, wherein the controller is configured to implement the machine learning algorithm to determine the switching frequency that optimizes one of the two or more objective functions by using another of the two or more objective functions as a constraint.

13. The power converter according to claim 9, wherein the controller is configured to sort the two or more target parameters by a priority order and to implement two or more machine learning algorithms to optimize the two or more objective functions according to the priority order.

14. The power converter according to claim 1, wherein the controller is configured to select the target parameter, determine the selected switching frequency, and control the switching device to operate at the selected switching frequency iteratively.

15. A converter comprising:
a first switching device;
a second switching device;
an inductive element, a first terminal of the inductive element being connected between the first switching device and the second switching device and a second terminal of the inductive element being an output terminal of the converter; and
a controller configured to control a switching frequency of the first switching device based on one of a plurality of switching frequency schedules, wherein
each of the plurality of switching frequency schedules indicates a value of a parameter of interest associated with each of a plurality of pairings of switching frequency values with values of a parameter of the converter, and
based on the one of the plurality of switching frequency schedules, the controller controls the switching frequency of the first switching device according to a measured value of the parameter and one of the switching frequency values paired with the measured value of the parameter associated with a desired value of the parameter of interest.

16. The converter according to claim 15, wherein the controller is configured to select the one of the plurality of switching frequency schedules based on one or more measured values indicating real-time conditions of the converter.

17. The converter according to claim 15, wherein the parameter of interest is efficiency computed using input current, input voltage, output current, and output voltage, and the desired value of the parameter of interest is a maximum efficiency associated with the measured value of the parameter and the switching frequency values.

18. A computer-implemented method for controlling a power converter, the method comprising:
obtaining parameters of the power converter, wherein
the parameters are measured or computed, and
one or more of the parameters are real-time measurements from one or more sensors;
selecting a target parameter, wherein
the target parameter is one of the parameters,
the target parameter is represented as an objective function that defines criteria for optimizing the objective function as minimizing, maximizing, or obtaining a particular value for the target parameter,
implementing a machine learning algorithm to determine a selected switching frequency of a switching device of the power converter that optimizes the objective function, and
controlling the switching device to operate at the selected switching frequency.

19. The method according to claim 18, further comprising implementing a probe and observe algorithm as the machine learning algorithm to optimize the objective function representing the target parameter by incrementally changing the switching frequency and observing a resulting value of the target parameter.

20. The method according to claim 18, wherein implementing the machine learning algorithm includes implementing a trained machine learning model that predicts a value of the selected switching frequency.
